(19) United States
(12) Patent Application Publication
(10) Pub. No.: US 2010/0236309 A1
(43) Pub. Date: Sep. 23, 2010

(54) METHOD AND MATRIX FOR ENHANCING GROWTH MEDIA

(76) Inventor: Wayne M. Celia, Paramus, NJ (US)

Correspondence Address: David Chen, IP Attorneys Group, LLC, 57 Plains Road, Suite 3A, Milford, CT, 06461, US

(21) Appl. No.: 12/728,940

(22) Filed: Mar. 22, 2010

Related U.S. Application Data
(60) Provisional application No. 61/162,390, filed on Mar. 23, 2009.

(51) Int. Cl. C05F 11/00; C05C 11/00

(52) U.S. Cl. 71/23; 71/27

(57) ABSTRACT

The invention relates to a growth media including a charred organic matter, a hydrophilic polyurethane prepolymer, and water for mixing said hydrophilic polyurethane prepolymer and said charred organic matter together into a malleable mixture. The invention also relates to a method of providing the growth media.

### CROSS REFERENCED TO RELATED APPLICATION

This patent application claims priority to and the benefit of U.S. Provisional Patent Application No. 61/162,390 filed Mar. 23, 2009, titled “Improved Growth Media Using Hydrophilic Foam,” which is incorporated herein by reference in its entirety.

### BACKGROUND OF THE INVENTION

Green roofing can provide many benefits to building managers and occupants as well as to local ecosystems. In natural ecosystems, vegetation and soil often affect the flux of moisture and of heat. When coupled with man-made structures, the services that vegetation provide can be harnessed for the mutual benefit of humans and the environment. Benefits include a reduction in storm surge, a potential lessening of the urban heat island effect, and lowered energy costs for the underlying building.

A living layer atop a building behaves very differently than a standard, impervious roof. Storm surge normally associated with impervious surfaces is avoided due to the absorbent capabilities of soil which eases the strain on municipal stormwater systems meaning that smaller, less expensive systems can be installed. Additionally, evaporation and transpiration remove both excess moisture and heat from the roof surface.

However, in green roof applications, soil depth and, subsequently, plant type are limited due to the load-bearing capacity of roofs. Thus, drought tolerant plant species in thin-layer soils are often used. Soils with a high organic matter content help to retain enough moisture and support vegetation, but in warmer climates, organic matter decomposes quickly and soils lose water holding capacity and fertility over time.

One type of green roof includes a combination of peat moss and dirt. However, peat moss is generally flammable and often renders the entire green roof unacceptable or unsafe.

What is desired, therefore, is a growth media that uses drought tolerant plant species in thin-layer soils but with reduced decomposition and increased water holding capacity.

### SUMMARY OF THE INVENTION

It is therefore an object of the invention to provide a growth media that promotes plant growth with reduced erosion and increased water holding capacity.

Another desire is a growth media that is malleable so it may be used in a wide array of applications.

These and other objects are achieved by a growth media that uses a polyurethane matrix infused with organic components and a water absorbing polymer to better retain moisture. The invention also deposits or disperses minerals essential in the polymer for plant growth. The material retains more moisture than prior art growth media with lower initial density. Recalcitrant organic matter and minerals are bound in the matrix releasing nutrients slowly for plant root uptake. The invention is an organic matter-polymer matrix, which promotes plant growth.

The growth media comprises a matrix including a charred organic matter, a hydrophilic polyurethane prepolymer, and water for mixing said hydrophilic polyurethane prepolymer and said charred organic matter together into a malleable mixture.

In another embodiment, the charred organic matter is selected from the group consisting of pine biomass, peanut biomass, paulownia biomass, and combinations thereof. In some of these embodiments, the pine biomass is between approximately 12 and approximately 15 weight percent of the matrix. In an optional embodiment, the peanut biomass is between approximately 10 and approximately 12 weight percent of the matrix. In a further embodiment, the paulownia biomass is between approximately 13 and approximately 20 weight percent of the matrix.

In other embodiments, the matrix includes a surfactant of approximately 1 weight percent of the matrix. In another embodiment, the matrix includes a citric acid of approximately 0.31 weight percent of the matrix.

In some embodiments, the water is between approximately 44.3 and approximately 36.7 weight percent of the matrix.

In further embodiments, the hydrophilic polyurethane prepolymer is between approximately 8 and approximately 15 weight percent of the matrix.

In another aspect of the invention, a method of providing a matrix for enhancing growth includes the steps of charring an organic matter, providing a hydrophilic polyurethane prepolymer, and mixing the hydrophilic polyurethane prepolymer with the charred organic matter for dispersing the charred organic matter within the hydrophilic polyurethane prepolymer.

In another embodiment, the method selects the charred organic matter from the group consisting of pine biomass, peanut biomass, paulownia biomass, and combinations thereof. In some of these embodiments, the method includes charring between approximately 13 and approximately 20 weight percent of paulownia biomass. In an optional embodiment, the method mixes approximately 1 weight percent of a surfactant into the matrix. In yet a further embodiment, the method mixes approximately 0.31 weight percent of a citric acid into the matrix.

In some embodiments, the method includes mixing between approximately 44.3 and approximately 36.7 weight percent of water into the matrix for providing a slurry.

In another embodiment, the method includes mixing between approximately 8 and approximately 15 weight percent of the hydrophilic polyurethane prepolymer into the matrix.

In a more specific embodiment, a matrix for enhancing growth includes a charred organic matter comprising a pine biomass, a peanut biomass, and a paulownia biomass; a hydrophilic polyurethane prepolymer; a surfactant; a citric acid; and the charred organic matter, the surfactant, and the citric acid are dispersed within the hydrophilic polyurethane prepolymer.

In one embodiment, the matrix includes water between approximately 36.7 and approximately 44.3 weight percent of the matrix.

In another embodiment, the hydrophilic polyurethane prepolymer is between approximately 8 and approximately 15 weight percent of the matrix.

### BRIEF DESCRIPTION OF DRAWINGS

FIG. 1 depicts the matrix in accordance with the invention.

### DETAILED DESCRIPTION

The invention relates to organic matter, such as various biomass and thermochemically altered biomass, embedded in a medium for enhancing growth, where such organic matter includes, but are not limited to, cotton, pine, and peanut residues. The invention discovered such organic matter are superior to prior art peat moss because, among other reasons, the organic matter, particularly paulownia, is more fire resistant or flame retardant. By combining these media with a TDI or MDI based hydrophilic foam, a superior growth media is formed. It is also possible to further enhance this material with the additional of additional nutrient sources or other materials to enhance plant growth or disease or insect resistance. This combination is unique and superior to existing growth media both for various applications, such as green roof and general horticulture uses.

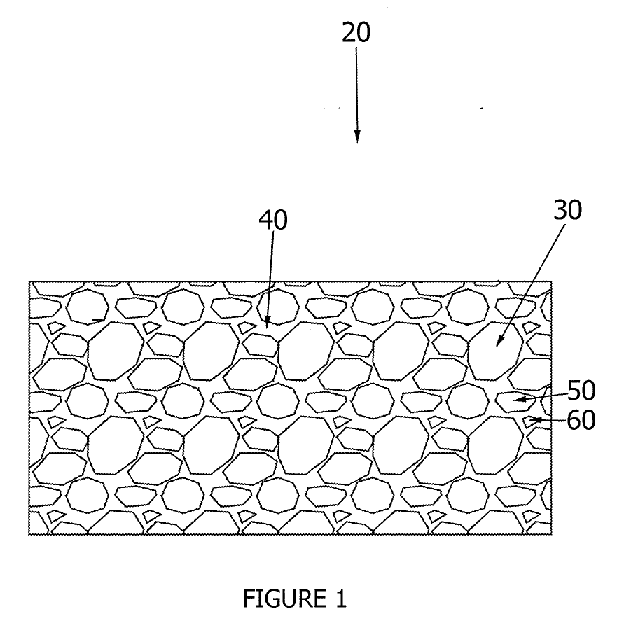

In accordance with one embodiment of the invention, and shown in FIG. 1, matrix 20 is provided for enhancing growth. Matrix 20 includes charred organic matter 30 dispersed within hydrophilic polyurethane prepolymer 40. As shown, matrix 20 enhances growth with improved flammability resistance because charred organic matter 30 is resistant to becoming flammable, wherein prior art peat moss is empirically tested and known to be more flammable that charred organic mater 30.

Matrix 20 is a fully reacted dried hydrophilic foam, which can be applied onto surfaces or substrates, such as a roof, garden, wall, or any location where growth is desired. Because matrix 20 is without dirt or with a negligible amount of dirt, erosion is reduced. Moreover, because hydrophilic polyurethane prepolymer 40 absorbs and holds approximately 10-20 times more water than dirt, the requirement of watering matrix 20 to maintain or promote growth is reduced. Hence, reduced erosion and reduced watering are advantages of matrix 20 over the prior art.

In some embodiments, charred organic matter 30 and hydrophilic polyurethane prepolymer 40 are mixed with water to provide a slurry or malleable mixture which is easier to form into any physical shape. In some cases, the mixture or slurry is dried into tiles, which is then cut and applied to roofing or walls. In other cases, the slurry or mixture is dried and ground up into a powder. In further cases, the slurry or mixture is applied to a substrate and later dried, wherein evaporation of the water results in matrix 20.

In some embodiments, water is approximately 55 and approximately 25 weight percent of matrix 20. In other embodiments, water is approximately 50 and approximately 30 weight percent of matrix 20. In further embodiments, water is approximately 44.3 and approximately 36.7 weight percent of matrix 20.

In another embodiment, charred organic matter 30 is selected from the group consisting of pine biomass, peanut biomass, paulownia biomass, and combinations thereof.

In some embodiments where pine biomass is used, there is between approximately 1 and approximately 35 weight percent of the matrix. In other embodiments where pine biomass is used, there is between approximately 5 and approximately 25 weight percent of the matrix. In further embodiments where pine biomass is used, there is between approximately 12 and approximately 15 weight percent of the matrix.

In some embodiments where peanut biomass is used, there is between approximately 1 and approximately 30 weight percent of the matrix. In other embodiments where peanut biomass is used, there is between approximately 5 and approximately 20 weight percent of the matrix. In further embodiments where peanut biomass is used, there is between approximately 10 and approximately 12 weight percent of the matrix.

In some embodiments where paulownia biomass is used, there is between approximately 5 and approximately 40 weight percent of the matrix. In other embodiments where paulownia biomass is used, there is between approximately 10 and approximately 30 weight percent of the matrix. In further embodiments where paulownia biomass is used, there is between approximately 13 and approximately 20 weight percent of the matrix.

In another embodiment, matrix 20 includes surfactant 50 for controlling a physical property of hydrophilic polyurethane prepolymer 40, such as cell size. A larger cell size promotes plant growth by enhancing oxygen exchange with the atmosphere and retaining moisture, much like pores. However, if a cell size is too large, water will leak or spill out. In some embodiments, surfactant 50 is between approximately 0 and approximately 10 weight percent of the matrix. In other embodiments, surfactant 50 is between approximately 0 and approximately 3 weight percent of the matrix. In a further embodiment, matrix 20 includes surfactant 50 in an amount of approximately 1 weight percent of the matrix.

In another embodiment, matrix 20 includes citric acid 60 for controlling a pH level of matrix 20, where a controlled pH level slows a reaction time of prepolymer 40 and charred organic matter 30. Without citric acid 60, the reaction time may occur so quickly that matrix 20 is not properly cured or charred organic matter 30 may not be adequately dispersed throughout matrix 20. In some embodiments, reaction time is desired to be after charred organic matter 30 is homogeneously mixed in matrix 20. In a further embodiment, matrix 20 includes citric acid 60 in an amount of approximately 0.31 weight percent of the matrix.

In yet another embodiment, citric acid 60 slows the reaction time between prepolymer 40 and water (with any of the ingredients, including charred organic matter 30). This is desired so that matrix 20 can be manipulated into the desired physical shape before exothermic reaction occurs and the foam is formed. Citric acid 60 shows this exothermic reaction by lowering the pH.

In further embodiments, when reacted with matrix 20, surfactant 50 and citric acid 60 cannot be seen because they are embodied within prepolymer 40.

In some embodiments, hydrophilic polyurethane prepolymer 40 is used for inhibiting drying or cracking of matrix 20, wherein prepolymer 40 is between approximately 5 and approximately 40 weight percent of the matrix. In other embodiments where paulownia biomass is used, there is between approximately 10 and approximately 30 weight percent of the matrix. In some embodiments, hydrophilic polyurethane prepolymer 40 is between approximately 8 and approximately 15 weight percent of the matrix.

Water is for facilitating mixing and dispersion of the other components within matrix 20. When water is mixed with hydrophilic polyurethane prepolymer 40, charred organic matter 30, and other constituents to comprise matrix 20, a malleable matter or slurry is provided, in which it may be manipulated to form customer desired physical characteristics.

In some embodiments, the malleable mixture or slurry is dried into tiles or a flat sheet, which is then cut and applied to roofing or walls. In other cases, the slurry or mixture is dried and ground up into a powder.

In further cases, the slurry or mixture is applied to a substrate and later dried, wherein evaporation of the water results in matrix 20. When the malleable matter or slurry is applied to a roof, wall, or any other medium or substrate where plant growth is desired, matrix 20 dries after application.

Regardless of the application, water eventually evaporates out of matrix 20, but the other constituents remain. Once water evaporates, the percentages of the remaining constituents that provide matrix 20 increases because water is no longer a component of matrix 20.

For example, if water was originally 44.3% of matrix 20 and paulownia was originally 13% of matrix 20, evaporation of water results in paulownia becoming approximately 29.3% of matrix 20. The percentages of the other remaining constituents will also increase in like manner.

In another aspect of the invention, method 100 for providing a matrix for enhancing growth includes the steps of charring 104 an organic matter, providing 108 a hydrophilic polyurethane prepolymer, and mixing 112 the hydrophilic polyurethane prepolymer with the charred organic matter for dispersing the charred organic matter within the hydrophilic polyurethane prepolymer.

In some embodiments, method 100 includes the step of selecting the charred organic matter from the group consisting of pine biomass, peanut biomass, paulownia biomass, and combinations thereof.

In other embodiments, method 100 includes charring 104 between approximately 13 and approximately 20 weight percent of paulownia biomass.

In further embodiments, method 100 mixes 116 approximately 1 weight percent of a surfactant into the matrix. In another embodiment, method 100 mixes 118 approximately 0.31 weight percent of a citric acid into the matrix.

In further embodiments, method 100 includes mixing 122 between approximately 44.3 and approximately 36.7 weight percent of water into the matrix for providing a slurry. In yet another embodiment, method 100 includes mixing 126 between approximately 8 and approximately 15 weight percent of the hydrophilic polyurethane prepolymer into the matrix.

The following table comprises empirical data of charred organic biomass 30 that are dispersed throughout matrix 20.

TABLE 1

| | | | Pyrolysis |
|---|---|---|---|
| Feedstock | Form | Particle size | Temperature (° C.) |
| pine chip | char | powder | 400 |
| | | | 600 |
| | | granule | 400 |
| | | | 600 |
| peanut hull | char | powder | 400 |
| | | | 600 |
| | | granule | 400 |
| | | | 600 |
| | biomass | granule | none |
| paulownia | biomass | granule | none |
| | | silica-coated granule | none |
| | | Total # of materials | 11 |
| | | ×3 reps | 33 |

1. A matrix for enhancing growth, comprising
a charred organic matter;
a hydrophilic polyurethane prepolymer; and
water for mixing said hydrophilic polyurethane prepolymer and said charred organic matter together into a malleable mixture.

2. The matrix according to claim 1, wherein said charred organic matter is selected from the group consisting of pine biomass, peanut biomass, paulownia biomass, and combinations thereof.

3. The matrix according to claim 2, wherein said pine biomass is between approximately 12 and approximately 15 weight percent of the matrix.

4. The matrix according to claim 2, wherein said peanut biomass is between approximately 10 and approximately 12 weight percent of the matrix.

5. The matrix according to claim 2, wherein said paulownia biomass is between approximately 13 and approximately 20 weight percent of the matrix.

6. The matrix according to claim 1, further comprising a surfactant of approximately 1 weight percent of the matrix.

7. The matrix according to claim 1, further comprising a citric acid of approximately 0.31 weight percent of the matrix.

8. The matrix according to claim 1, wherein said water is between approximately 44.3 and approximately 36.7 weight percent of the matrix.

9. The matrix according to claim 1, wherein said hydrophilic polyurethane prepolymer is between approximately 8 and approximately 15 weight percent of the matrix.

10. A method of providing a matrix for enhancing growth, comprising the steps of:
charring an organic matter;
providing a hydrophilic polyurethane prepolymer;
mixing the hydrophilic polyurethane prepolymer with the charred organic matter for dispersing the charred organic matter within the hydrophilic polyurethane prepolymer.

11. The method according to claim 10, further comprising the step of selecting the charred organic matter from the group consisting of pine biomass, peanut biomass, paulownia biomass, and combinations thereof.

12. The method according to claim 11, further comprising the step of charring between approximately 13 and approximately 20 weight percent of paulownia biomass.

13. The method according to claim 10, further comprising the step of mixing approximately 1 weight percent of a surfactant into the matrix.

14. The method according to claim 10, further comprising the step of mixing approximately 0.31 weight percent of a citric acid into the matrix.

15. The method according to claim 10, further comprising the step of mixing between approximately 44.3 and approximately 36.7 weight percent of water into the matrix for providing a slurry.

16. The method according to claim 10, further comprising the step of mixing between approximately 8 and approximately 15 weight percent of the hydrophilic polyurethane prepolymer into the matrix.

17. A matrix for enhancing growth, comprising:
a charred organic matter comprising a pine biomass, a peanut biomass, and a paulownia biomass;
a hydrophilic polyurethane prepolymer;
a surfactant;
a citric acid; and
said charred organic matter, said surfactant, and said citric acid are dispersed within said hydrophilic polyurethane prepolymer.

18. The matrix according to claim 17, further comprising water between approximately 36.7 and approximately 44.3 weight percent of the matrix.

19. The matrix according to claim 17, wherein said hydrophilic polyurethane prepolymer is between approximately 8 and approximately 15 weight percent of the matrix.
